(19) United States
(12) Patent Application Publication
(10) Pub. No.: US 2011/0199696 A1
(43) Pub. Date: Aug. 18, 2011

(54) PIEZOELECTRIC ACTUATOR ASSEMBLY AND OPTICAL SYSTEM INCLUDING THE SAME

(75) Inventors: Seung-hwan Lee, Hwaseong-si (KR); Jin-gi Lee, Changwon-si (KR); Jung-ho Park, Changwon-si (KR)

(73) Assignee: Samsung Electronics Co., Ltd., Suwon-si (KR)

(21) Appl. No.: 13/005,096

(22) Filed: Jan. 12, 2011

(30) Foreign Application Priority Data
Feb. 16, 2010 (KR) 10-2010-0013854

(51) Int. Cl. G02B 7/04; H02N 2/04

(52) U.S. Cl. 359/824; 310/323.16

(57) ABSTRACT

An optical system includes a housing, a lens assembly, and a piezoelectric actuator assembly. The lens assembly includes a lens unit having at least one lens, and a lens frame that supports the lens unit and moves in the housing. The piezoelectric actuator assembly includes a base plate coupled to the housing, an elastic plate coupled to the base plate and including a protrusion protruding from a first surface of the elastic plate, a piezoelectric element coupled to a second surface of the elastic plate wherein the piezoelectric element vibrates when receiving electricity and transmits the vibration to the elastic plate, and a moving portion that supports the lens frame. The moving portion has a first end supported by the protrusion of the elastic plate and a second end slidably coupled to the base plate.

### CROSS-REFERENCE TO RELATED PATENT APPLICATION

This application claims the priority benefit of Korean Patent Application No. 10-2010-0013854, filed on Feb. 16, 2010, in the Korean Intellectual Property Office, the disclosure of which is incorporated herein in its entirety by reference.

### BACKGROUND

1. Field of the Invention

Embodiments relate to a piezoelectric actuator assembly and an optical system including the same, and more particularly, to a piezoelectric actuator assembly that minimizes a change in driving characteristics due to an assembling tolerance by being manufactured as a module to maintain an integrally assembled state, and an optical system including the piezoelectric actuator assembly.

2. Description of the Related Art

An optical system including optical elements, such as lenses, includes a lens driving device for moving the lenses. The lens driving device performs zooming or auto-focusing by moving the lenses to change a distance between the lenses.

If the lens driving device uses a driving unit such as a stepper motor, a deceleration gear and a cam should be used to change a rotational motion of the stepper motor into a linear motion, thereby increasing the size of the optical system, complicating the structure of the optical system, causing an error due to backlash during forward rotation or backward rotation, increasing power consumption, and generating large amounts of current and heat.

A piezoelectric element driven by a piezoelectric effect has recently been widely used to move the lenses of the optical system. A very small driving motor may be manufactured by using such a piezoelectric element.

However, since a conventional optical system using a piezoelectric element uses a gear or a cam in order to change a deformation of the piezoelectric element into a driving motion for moving the lenses, the structure of the optical system is complicated and it is difficult to achieve precise position control due to an error between mechanical elements.

### SUMMARY

Embodiments include a piezoelectric actuator assembly that moves a lens unit, and an optical system including the piezoelectric actuator assembly.

Embodiments also include a piezoelectric actuator assembly that achieves precise position control by minimizing an error between mechanical elements, and an optical system including the piezoelectric actuator assembly.

Embodiments also include a piezoelectric actuator assembly that minimizes a change in driving characteristics due to an assembling tolerance by being manufactured as a module to maintain an integrally assembled state.

According to an embodiment, a piezoelectric actuator assembly includes: a base plate; an elastic plate coupled to the base plate and including a protrusion protruding from a first surface of the elastic plate; a piezoelectric element disposed on a second surface of the elastic plate, wherein the piezoelectric element vibrates when receiving electricity and that transmits the vibration to the elastic plate; and a moving portion having a first end supported by the protrusion of the elastic plate and a second end slidably coupled to the base plate.

The piezoelectric actuator assembly may further include a sliding guide installed on the base plate to extend in one direction, wherein the moving portion is coupled to the sliding guide.

The piezoelectric actuator assembly may further include a detection sensor that detects a position of the moving portion that moves along the sliding guide.

The elastic plate may further include mounting portions coupled to the base plate, and an elastic support portion extending from the mounting portions toward the moving portion, the elastic support portion spaced apart from the base plate, wherein the protrusion is formed on the elastic support portion.

The protrusion may extend to have a predetermined length and be in line contact with the moving portion.

The piezoelectric element may vibrate so that an end of the protrusion moves along a circular trajectory.

The piezoelectric element may vibrate so that an end of the protrusion moves along an elliptical trajectory.

According to another embodiment, an optical system includes: a housing; a lens assembly including a lens unit having at least one lens, the lens assembly also including a lens frame that supports the lens unit and moves in the housing; and a piezoelectric actuator assembly including a base plate coupled to the housing, an elastic plate coupled to the base plate, the elastic plate having a protrusion protruding from a first surface of the elastic plate and a piezoelectric element coupled to a second surface of the elastic plate, wherein the piezoelectric element vibrates when receiving electricity and transmits the vibration to the elastic plate, and a moving portion that supports the lens frame, the moving portion having a first end supported by the protrusion of the elastic plate and a second end slidably coupled to the base plate.

The lens assembly may further include guide shafts disposed in the housing and that support the lens frame so that the lens frame moves.

The optical system may further include a guide unit that slidably couples the lens frame to the housing.

The guide unit may include guide grooves formed in the housing to extend in a direction in which the lens assembly slides, and sliders formed on corners of the lens frame that are inserted into the guide grooves.

The guide unit may further include rollers disposed on inner surfaces of the guide grooves that contact the sliders and slidably support the sliders.

### BRIEF DESCRIPTION OF THE DRAWINGS

The above and other features and advantages will become more apparent by describing in detail exemplary embodiments with reference to the attached drawings in which:

FIG. 1 is a perspective view of a piezoelectric actuator assembly, according to an embodiment;

FIG. 2 is an exploded perspective view illustrating a structural relationship between elements of the piezoelectric actuator assembly of FIG. 1, according to an embodiment;

FIG. 3 is a perspective view illustrating some elements of an optical system including the piezoelectric actuator assembly of FIG. 1, according to an embodiment;

FIG. 4 is a perspective view illustrating a housing coupled to the optical system of FIG. 3, according to an embodiment;

FIG. 5 is a graph illustrating a relationship between displacement and frequency of a conventional piezoelectric actuator assembly;

FIG. 6 is a cross-sectional view illustrating a state where an elastic plate of the piezoelectric actuator assembly of FIG. 1 is deformed leftward, according to an embodiment;

FIG. 7 is a cross-sectional view illustrating a state where the elastic plate of the piezoelectric actuator assembly of FIG. 1 is deformed rightward, according to an embodiment;

FIG. 8 is a cross-sectional view illustrating a state where the elastic plate of the piezoelectric actuator assembly of FIG. 1 is deformed upward, according to an embodiment;

FIG. 9 is a cross-sectional view illustrating a state where the elastic plate of the piezoelectric actuator assembly of FIG. 1 is deformed downward, according to an embodiment;

FIG. 10 is a cross-sectional view for explaining a motion trajectory of the elastic plate of the piezoelectric actuator assembly of FIG. 1, according to an embodiment;

FIG. 11 is a perspective view illustrating a piezoelectric element of the piezoelectric actuator assembly of FIG. 1, according to an embodiment;

FIG. 12 is a perspective view illustrating a modification of the piezoelectric element of the piezoelectric actuator assembly of FIG. 1, according to an embodiment;

FIG. 13 is a perspective view illustrating another modification of the piezoelectric element of the piezoelectric actuator assembly of FIG. 1, according to an embodiment;

FIG. 14 is a perspective view illustrating a modification of a protrusion of the piezoelectric actuator assembly of FIG. 1, according to an embodiment;

FIG. 15 is a perspective view illustrating another modification of the protrusion of the piezoelectric actuator assembly of FIG. 1, according to an embodiment; and

FIG. 16 is a perspective view of an optical system including a piezoelectric actuator assembly, according to another embodiment.

### DETAILED DESCRIPTION

Embodiments will now be described more fully with reference to the accompanying drawings.

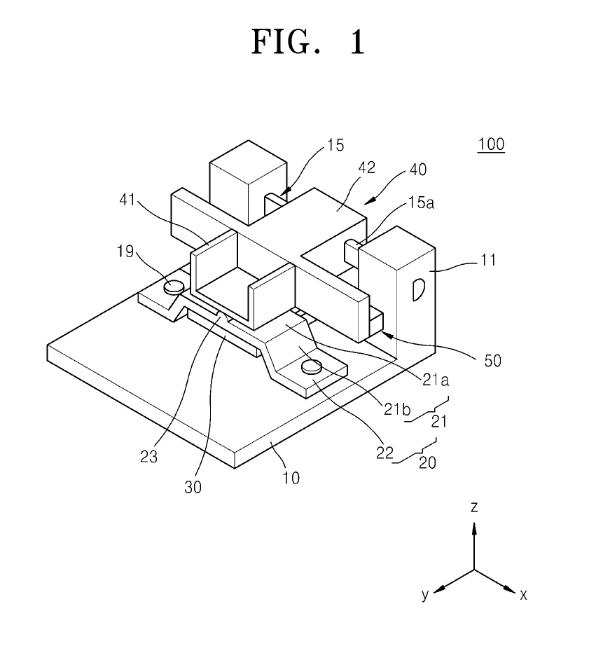

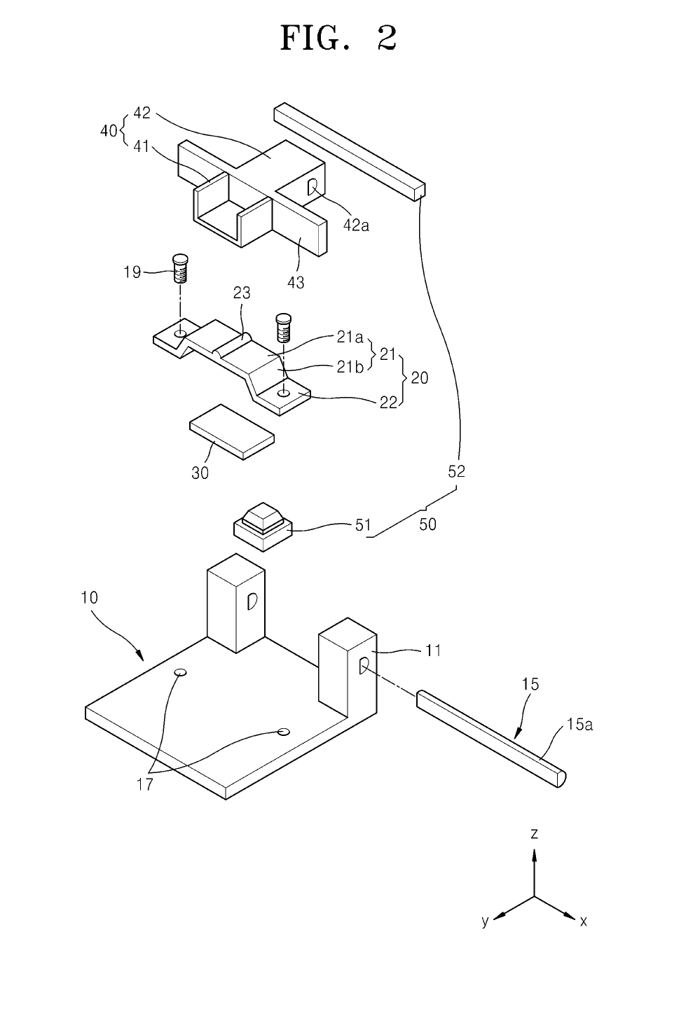

FIG. 1 is a perspective view of a piezoelectric actuator assembly 100, according to an embodiment. FIG. 2 is an exploded perspective view illustrating a structural relationship between elements of the piezoelectric actuator assembly 100 of FIG. 1, according to an embodiment.

Referring to FIGS. 1 and 2, the piezoelectric actuator assembly 100 includes a base plate 10, an elastic plate 20 coupled to the base plate 10, a piezoelectric element 30 disposed on the elastic plate 20 and designed to vibrate, and a moving portion 40 slidably coupled to the base plate 10.

The base plate 10, which supports the elastic plate 20, may be coupled to a fixed structure of an optical system that is described elsewhere herein.

The elastic plate 20 is deformed by vibration generated by the piezoelectric element 30 and transmits the vibration. The elastic plate 20 may be formed of an elastic material. For example, the elastic plate 20 may be formed by bending a plate formed of metal such as aluminium or stainless steel. Alternatively, the elastic plate 20 may be formed of synthetic resin or rubber. A protrusion 23 protrudes from a first surface of the elastic plate 20. The protrusion 23 transmits the vibration of the elastic plate 20 to the moving portion 40 by contacting the moving portion 40.

The piezoelectric element 30 may be a multi-layered piezoelectric element including a stack of electrodes, or a single-layered piezoelectric element. When alternating current (AC) is applied to the piezoelectric element 30, the piezoelectric element 30 generates vibration according to a waveform of the AC. The piezoelectric element 30 may be disposed on a second surface of the elastic plate 20 opposite to the first surface of the elastic plate 20 on which the protrusion 23 is formed.

The moving portion 40 has a first end supported by the protrusion 23 of the elastic plate 20, and a second end slidably coupled to the base plate 10.

Two support columns 11 are installed on the base plate 10 to extend in a direction perpendicular to the base plate 10. A sliding guide 15 is fixed to the support columns 11 to extend in a direction parallel to the base plate 10. Although the sliding guide 15 may have a semi-circular cylindrical shape in FIGS. 1 and 2, the present embodiment is not limited thereto and the sliding guide 15 may have a polygonal cylindrical shape such as a rectangular cylindrical shape.

The moving portion 40 includes a sliding block 42. A coupling hole 42a is formed in the sliding block 42, and the sliding guide 15 is inserted into the coupling hole 42a. The sliding guide 15 may include a rotation limiting surface 15a for preventing the sliding block 42 from rotating around the sliding guide 15. The coupling hole 42a of the sliding block 42 has a shape conforming to the sliding guide 15 having the rotation limiting surface 15a.

Since the sliding guide 15 is inserted into the coupling hole 42a of the sliding block 42, the moving portion 40 can slide along the sliding guide 15.

The elastic plate 20 includes mounting portions 22 coupled to the base plate 10, and an elastic support portion 21 extending from the mounting portions 22 toward the moving portion 40 and spaced apart from the base plate 10. The mounting portions 22 are coupled to the base plate 10 by coupling members 19 that are inserted into insertion holes 17 of the base plate 10. The coupling members 19 may be rivets or bolts.

The elastic support portion 21 includes bent portions 21 b bent away from the base plate 10 and a support portion 21 a formed between the bent portions 21 b. The protrusion 23 is formed on a surface of the support portion 21 a facing the moving portion 40, that is, on the first surface of the elastic plate 20. The protrusion 23 is integrally formed with the elastic plate 20 in FIGS. 1 and 2. However, the present embodiment is not limited thereto, and the protrusion 23 may be separately formed of plastic or rubber and then attached to the first surface of the elastic plate 20.

The piezoelectric actuator assembly 100 may further include a detection sensor 50 that detects a position of the moving portion 40 that moves along the sliding guide 15. The detection sensor 50 includes a magnetic bar unit 52 in which a plurality of magnets are connected to one another, and a detecting unit 51 that detects magnetic properties of the magnetic bar unit 52. The magnetic bar unit 52 is coupled to wings 43 extending from both sides of the moving portion 40, and the detecting unit 51 is attached to the base plate 10.

Since the protrusion 23 extends in a width direction of the elastic plate 20, the protrusion 23 may be in line contact with the moving portion 40.

The moving portion 40 includes a coupling stage 41 to which a moving body, which is to be moved by vibration of the elastic plate 20 and the piezoelectric element 30, is coupled.

Once the piezoelectric actuator assembly 100 is completely assembled as shown in FIG. 1, since a bottom surface of the coupling stage 41 is elastically supported by the protrusion 23 of the elastic plate 20, an upward pressure is exerted on the piezoelectric actuator assembly 100 in the Z-axis direction of FIGS. 1 and 2. Hence, even after the piezoelectric actuator assembly 100 is assembled to be installed in a lens driving module mounted on an optical system, the influence of an assembling tolerance can be minimized. That is, since the protrusion 23 of the elastic plate 20 is firmly attached to the bottom surface of the coupling stage 41 and provides an elastic force to the coupling stage 41, the risk of displacements of elements including the coupling stage 41 while assembling is very low.

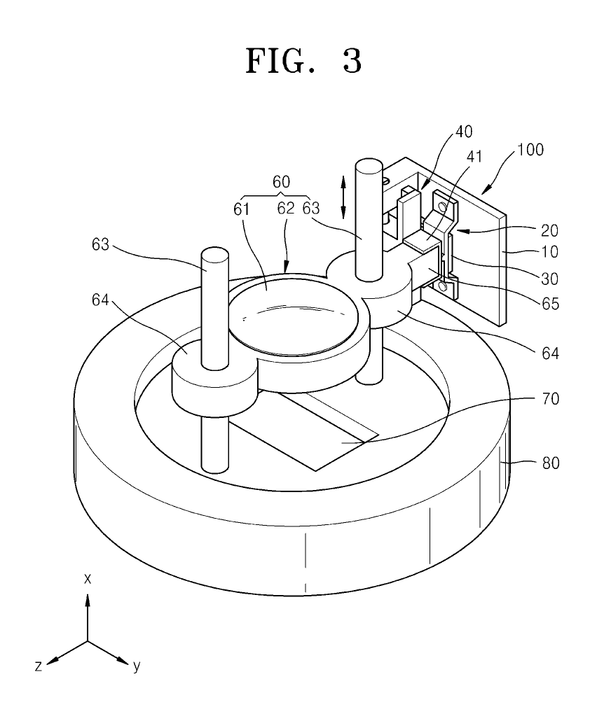

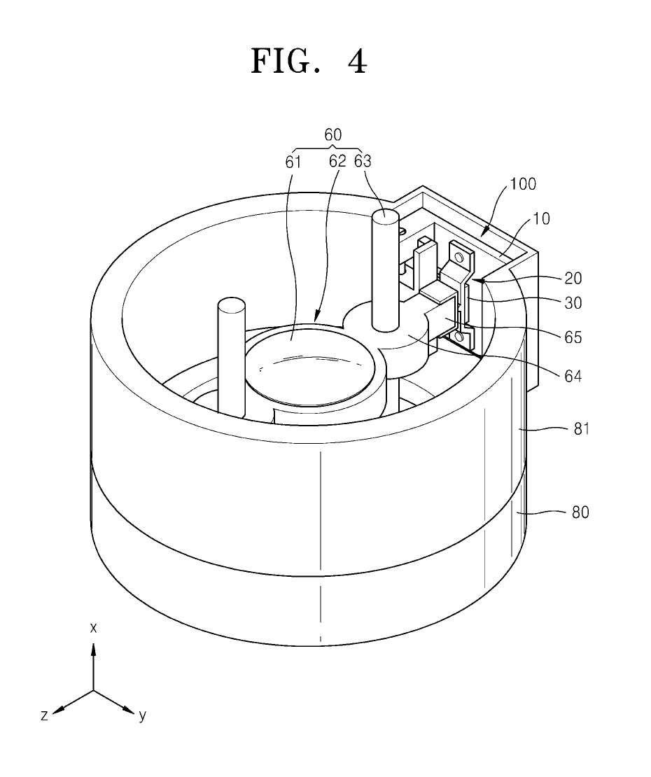

FIG. 3 is a perspective view illustrating some elements of an optical system including the piezoelectric actuator assembly 100 of FIG. 1, according to an embodiment. FIG. 4 is a perspective view illustrating a housing 81 coupled to the optical system of FIG. 3, according to an embodiment.

Referring to FIGS. 3 and 4, the optical system includes the piezoelectric actuator assembly 100 illustrated in FIGS. 1 and 2. The piezoelectric actuator assembly 100 of the optical system is used as a lens driving module for moving a lens unit 61. In general, a lens driving module may perform zooming or auto-focusing by moving lenses to change a distance between the lenses.

A lens driving module used by a conventional optical system may include a very small motor for driving lenses. If the lens driving module used by the conventional optical system uses a stepper motor that is an electromagnetic motor, since a deceleration gear and a cam should be used to change a fast rotational motion of the stepper motor into a linear motion, the structure of the conventional optical system is complicated, an error occurs due to backlash during forward or backward rotation, power consumption is increased, and large amounts of current and heat are generated.

However, the optical system of FIGS. 3 and 4 employs the piezoelectric actuator assembly 100, which is driven by a piezoelectric effect of the piezoelectric element 30, as a unit for generating power to move the lens unit 61. Since the piezoelectric actuator assembly 100 can be manufactured as a very small motor, can obtain high torque during low speed operation, and can provide a precisely controlled amount of kinetic energy to the optical system, the piezoelectric actuator assembly 100 can be efficiently used as a small lens driving module.

The optical system includes a lens assembly 60 including the lens unit 61 including at least one lens, a lens frame 62 that supports the lens unit 61, guide shafts 63 that support the lens frame 62 so that the lens frame 62 moves, a housing 81 surrounding the lens assembly 60, and the piezoelectric actuator assembly 100.

The guide shafts 63 of the lens assembly 60 are coupled to a base portion 80. An image pickup device 70 may be disposed on the base portion 80. The lens unit 61 of the lens assembly 60 moves in an optical axis direction along the guide shafts 63 to direct light indicating an image of a subject onto the image pickup device 70.

Sliding portions 64 slidably fitted around the guide shafts 63 are disposed on ends of the lens frame 62 of the lens assembly 60. A connecting protrusion 65 is formed on an end of one of the sliding portions 64 and coupled to the coupling stage 41 of the piezoelectric actuator assembly 100.

Referring to FIG. 4, the housing 81 is coupled to the base portion 80 to surround the lens assembly 60, and the base plate 10 of the piezoelectric actuator assembly 100 is also coupled to the housing 81. Accordingly, once the piezoelectric element 30 vibrates in a state where the piezoelectric actuator assembly 100 is fixed to the housing 81, the vibration is transmitted through the elastic plate 20 to cause the lens assembly 60 to slide along the guide shafts 63.

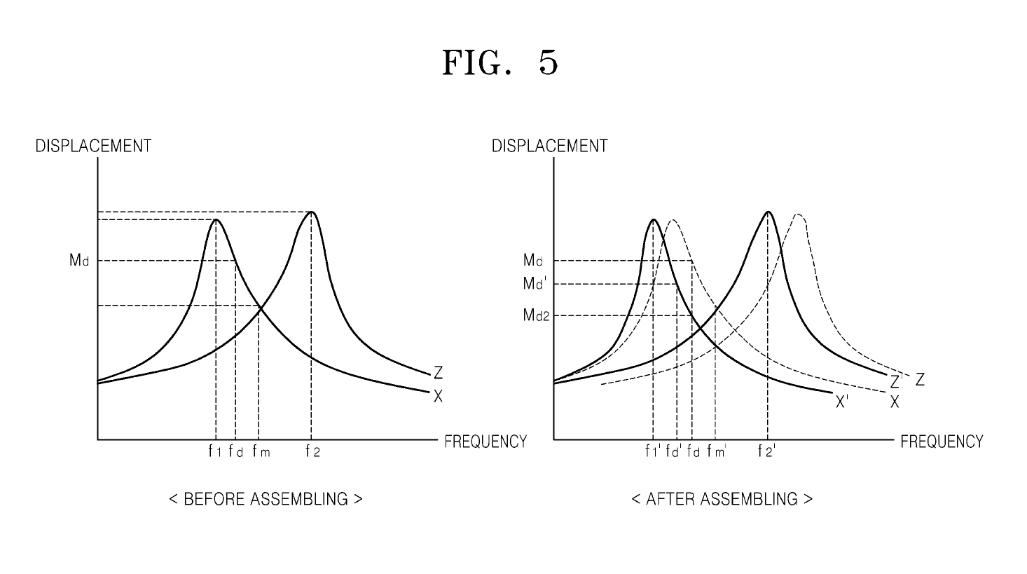

FIG. 5 is a graph illustrating a relationship between displacement and frequency of a conventional piezoelectric actuator assembly 100.

The piezoelectric actuator assembly 100 of FIG. 1 is manufactured as a module so that the elastic plate 20 elastically supports the moving portion 40 in the Z-axis direction in a state where the elastic plate 20 is coupled to the base plate 10.

Referring to the left graph of FIG. 5 illustrating a state before assembling, an optical frequency fd may be obtained by measuring a displacement that varies according to a frequency of current applied to the piezoelectric element 30.

In FIG. 5, the horizontal axis represents a frequency of current applied to the piezoelectric element 30, f1 represents a resonance frequency during movement in the X-axis direction, fd represents an optimal frequency (operating frequency) at which the protrusion 23 of the elastic plate 20 is driven to move along an elliptical trajectory, fm is a center frequency at which the protrusion 23 of the elastic plate 20 is driven to move along a circular trajectory, and f2 represents a resonance frequency during movement in the Z-axis direction. The vertical axis represents the amount of displacement of the protrusion 23 of the elastic plate 20. Md represents an optimal displacement.

If a conventional piezoelectric actuator assembly, having characteristics as shown in the left graph of FIG. 5 illustrating a state before assembling, is assembled to be installed in an optical system, the conventional piezoelectric actuator assembly suffers a change in the driving characteristics as shown in the right graph of FIG. 5 illustrating a state after assembling. That is, the conventional piezoelectric actuator assembly that is not manufactured as a module to maintain an integrally assembled state suffers a change in the driving characteristics for the following reasons:

1) a position and attachment type of the conventional actuator assembly when the conventional actuator assembly is assembled to be installed in the optical system,

2) contact conditions, e.g., friction, between a lens assembly of the optical system and the conventional piezoelectric actuator assembly,

3) a pre-load set to the conventional piezoelectric actuator assembly before the conventional piezoelectric actuator assembly is assembled to be installed in the optical system,

4) positions, states, and sizes of wires and electrodes of a piezoelectric element which are soldered, and

5) a resonance bandwidth and shape of a spring used in the conventional actuator assembly.

After the conventional piezoelectric actuator assembly, which is not manufactured as a module, is installed in the optical system, the resonance frequencies f1 and f2 are changed to f1′ and f2′, respectively. Accordingly, the following problems occur:

1) if a driving frequency in the X-axis direction is maintained to be fd, since a displacement is changed from Md to Md2, the performance of the optical system is severely degraded, and

2) if the driving frequency in the X-axis direction is changed from fd to fd′, the performance of the optical system is slightly degraded from Md to Md′. In this case, a process of finding the driving frequency fd′ should be performed by using a measuring instrument on all products after the conventional piezoelectric actuator assembly is installed. Even though the driving frequency fd′ is found at an initial stage after the conventional piezoelectric actuator is assembled to be installed in the optical system, since the driving frequency fd′ is often changed according to temperature, hysteresis, and so on, the process of finding the driving frequency fd′ should be repeatedly performed. Also, although the process of finding the driving frequency fd′ is repeatedly performed, if the driving frequency fd′ is greatly changed, it is difficult to expect a normal performance of the optical system which corresponds to Md′.

The piezoelectric actuator assembly 100, however, can minimize performance degradation due to a change in driving characteristics which may occur after the piezoelectric actuator assembly 100 is assembled to be installed in the optical system. That is, since the piezoelectric actuator assembly 100 is manufactured as a module so that a state before the piezoelectric actuator assembly 100 is assembled to be installed in the optical system is not much different from a state after the piezoelectric actuator assembly 100 is assembled to be installed in the optical system, and thus a change in an optical frequency is maintained within a narrow allowable range, a difference between the optical frequency fd before assembling and the optical frequency fd′ after assembling can be minimized and a difference between the optimal displacements Md and Md′ can also be minimized, thereby enabling the optical system to reliably operate for a long time.

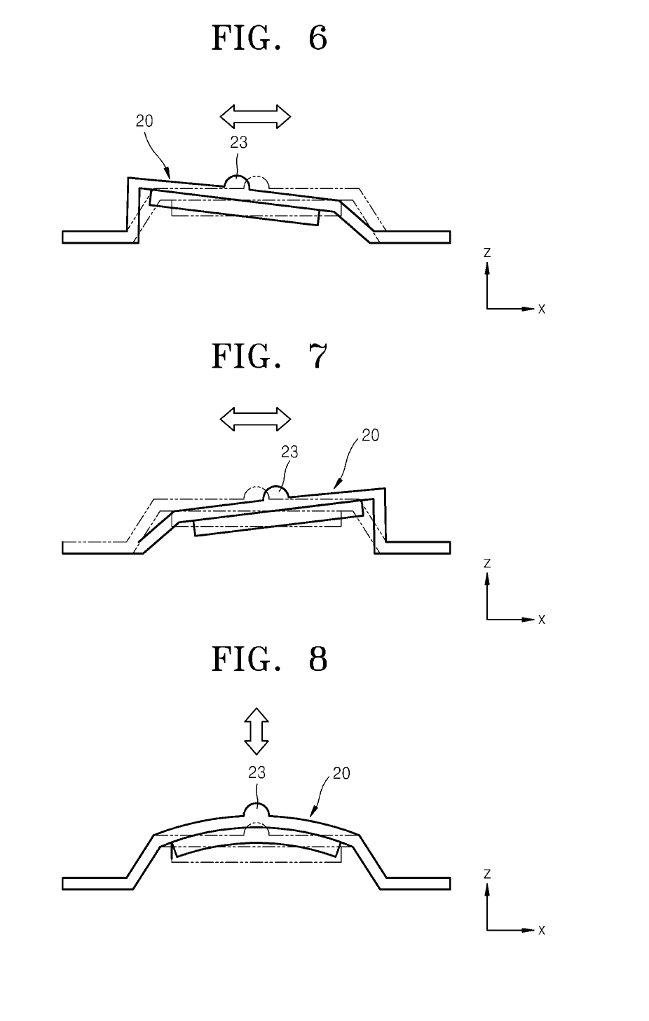

FIG. 6 is a cross-sectional view illustrating a state where the elastic plate 20 of the piezoelectric actuator assembly 100 of FIG. 1 is deformed leftward, according to an embodiment. FIG. 7 is a cross-sectional view illustrating a state where the elastic plate 20 of the piezoelectric actuator assembly 100 of FIG. 1 is deformed rightward, according to an embodiment.

Referring to FIGS. 6 and 7, since the elastic plate 20 is deformed by current applied to the piezoelectric actuator assembly 100 of FIG. 1, the protrusion 23 is moved rightward or leftward in the X-axis direction.

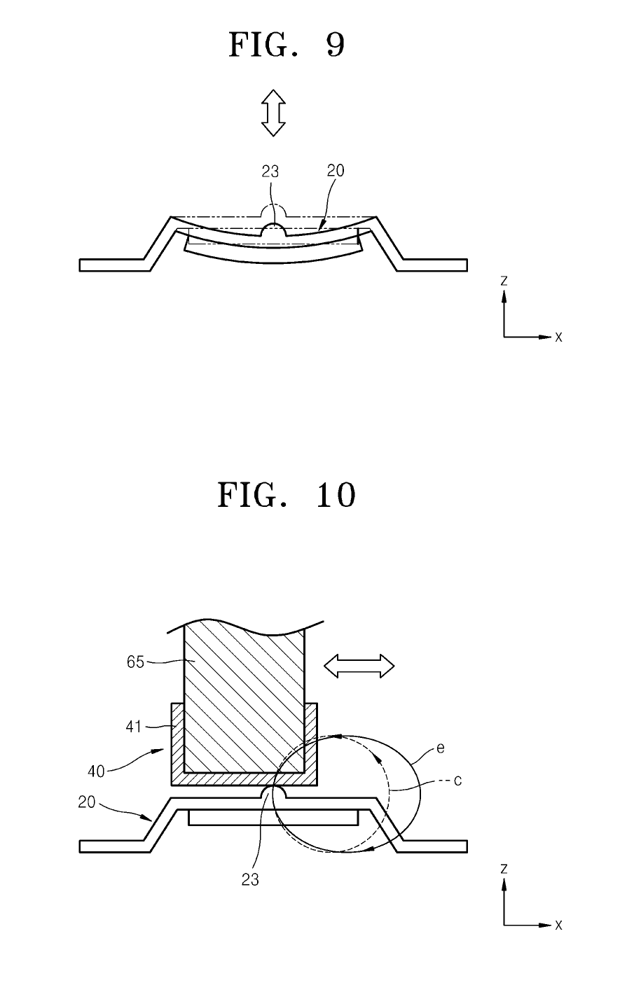

FIG. 8 is a cross-sectional view illustrating a state where the elastic plate 20 of the piezoelectric actuator assembly 100 of FIG. 1 is deformed upward, according to an embodiment. FIG. 9 is a cross-sectional view illustrating a state where the elastic plate 20 of the piezoelectric actuator assembly 100 of FIG. 1 is deformed downward, according to an embodiment.

Referring to FIGS. 8 and 9, since the elastic plate 20 is deformed by current applied to the piezoelectric actuator assembly 100, the protrusion 23 is moved upward or downward in the Z-axis direction.

FIG. 10 is a cross-sectional view for explaining a motion trajectory of the elastic plate 20 of the piezoelectric actuator assembly 100 of FIG. 1, according to an embodiment.

By controlling a frequency of AC applied to the piezoelectric actuator assembly 100 so that a horizontal motion in the X-axis direction of FIGS. 6 and 7 and a vertical motion in the Z-axis direction of FIGS. 8 and 9 overlap each other, the protrusion 23 of the elastic plate 20 may be driven to rotate along an elliptical trajectory “e” or a circular trajectory “c” as shown in FIG. 10. Accordingly, since the protrusion 23 repeatedly hits the bottom surface of the coupling stage 41 of the moving portion 40, the connecting protrusion 65 coupled to the coupling stage 41 horizontally moves in the X-axis direction.

FIG. 11 is a perspective view illustrating the piezoelectric element 30 of the piezoelectric actuator assembly 100 of FIG. 1, according to an embodiment.

Referring to FIG. 11, one piezoelectric element 30 is coupled to a bottom surface of the elastic support portion 21 of the elastic plate 20 of the piezoelectric actuator assembly 100.

The piezoelectric element 30 may be a multi-layered piezoelectric element in which a plurality of piezoelectric elements each having an electrode installed on a surface of a piezoelectric ceramic sheet are stacked. Alternatively, the piezoelectric element 30 may be a single-layered piezoelectric element.

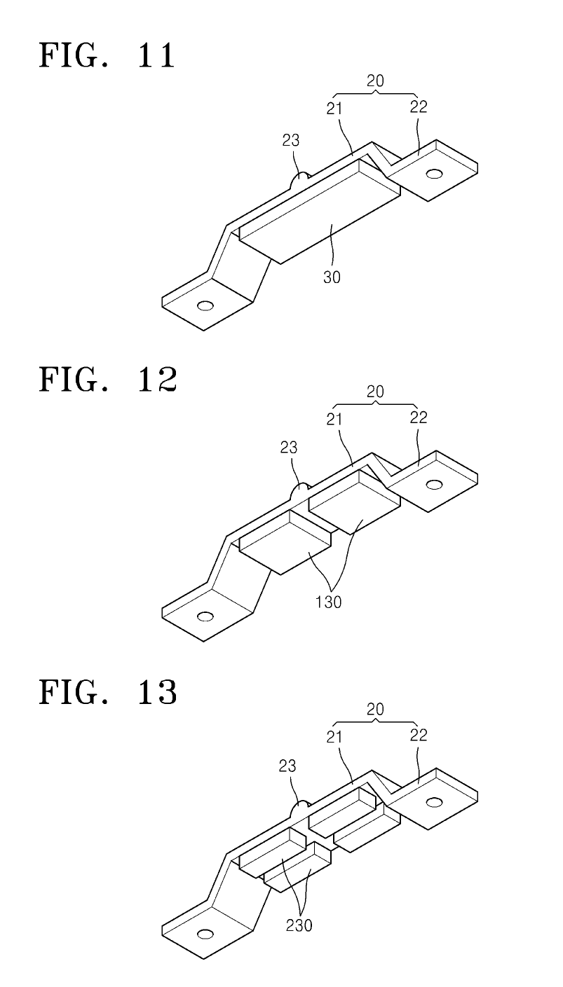

FIG. 12 is a perspective view illustrating a modification of the piezoelectric element 30 of the piezoelectric actuator assembly 100 of FIG. 1, according to an embodiment. FIG. 13 is a perspective view illustrating another modification of the piezoelectric element 30 of the piezoelectric actuator assembly 100 of FIG. 1, according to an embodiment.

Referring to FIGS. 12 and 13, although a piezoelectric element is disposed on the bottom surface of the elastic support portion 21 of the elastic plate 20 in both FIGS. 12 and 13, the number of piezoelectric elements is different. That is, two piezoelectric elements 130 are respectively disposed on either side of the protrusion 23 in FIG. 12, whereas four piezoelectric elements 230 are disposed around the protrusion 23 in FIG. 13.

A motion trajectory of the protrusion 23 according to a deformation of the elastic plate 20 may be easily obtained by applying currents having different phases to the piezoelectric elements 130 of FIG. 12. Likewise, a motion trajectory of the protrusion 23 may be easily obtained and precise control and a strong driving force may be achieved by applying currents having different phases to the piezoelectric elements 230 of FIG. 13.

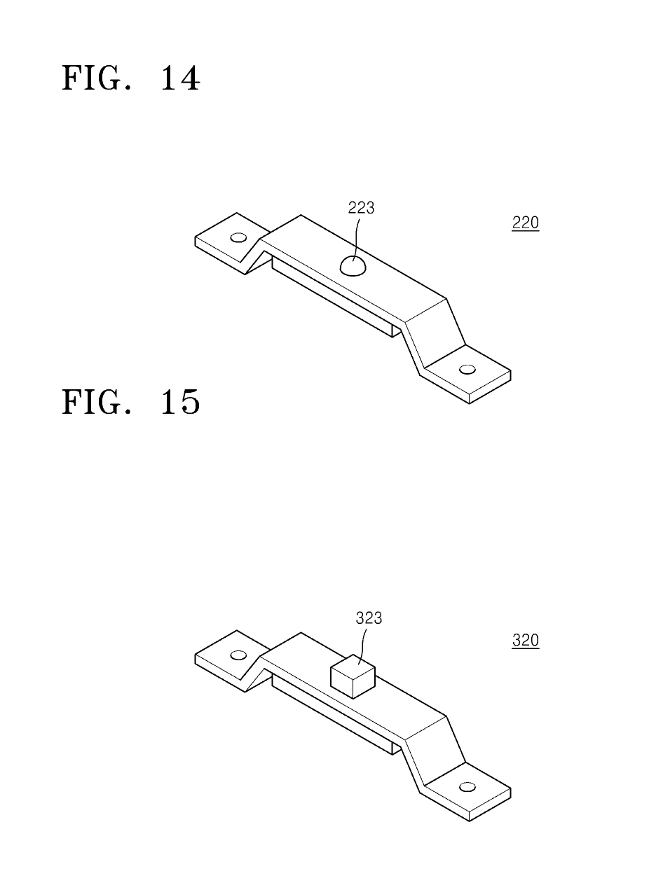

FIG. 14 is a perspective view illustrating a modification of the protrusion 23 of the piezoelectric actuator assembly 100 of FIG. 1, according to an embodiment.

Referring to FIG. 14, a protrusion 223 formed on a plastic plate 220 has a substantially semi-circular shape. While the protrusion 23 in FIGS. 1 through 13 extends in one direction and is in line contact with the moving portion 40, the protrusion 223 of FIG. 14 is in point contact with the moving portion 40 and transmits vibration.

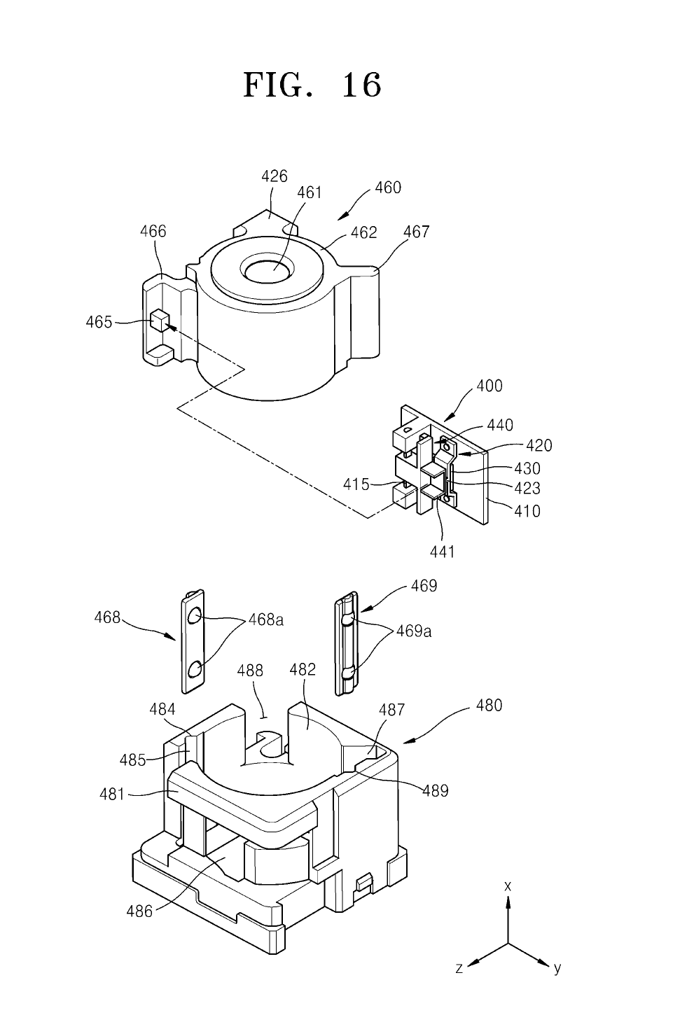

FIG. 15 is a perspective view illustrating another modification of the protrusion 23 of the piezoelectric actuator assembly 100 of FIG. 1, according to an embodiment.

Referring to FIG. 15, a protrusion 323 formed on an elastic plate 320 has a substantially rectangular parallelepiped shape. Accordingly, the protrusion 323 is in an area contact with the moving portion 40 and transmits vibration.

FIG. 16 is a perspective view of an optical system including a piezoelectric actuator assembly 400, according to another embodiment.

Referring to FIG. 16, the optical system is a camera module, and the piezoelectric actuator assembly 400 included in the optical system is a lens driving module that moves a lens assembly 460 in order to perform zooming or auto-focusing.

The optical system includes a housing 480, the lens assembly 460 that includes a lens unit 461 including at least one lens and a lens frame 462 that supports the lens unit 461 and moves in the housing 480, and the piezoelectric actuator assembly 400 that moves the lens assembly 460.

The piezoelectric actuator assembly 400 has a similar construction to that of the piezoelectric actuator assembly 100 of FIG. 1, and includes a base plate 410, an elastic plate 420 coupled to the base plate 410, a piezoelectric element 430 disposed on the elastic plate 420 and designed to vibrate, and a moving portion 440 slidably coupled to the base plate 410.

A protrusion 423 protrudes from a first surface of the elastic plate 420. The protrusion 423 transmits vibration of the elastic plate 420 to the moving portion 440 by contacting a coupling stage 441 of the moving portion 440.

A sliding guide 415 is installed on the base plate 410 to extend in a direction parallel to the base plate 410, and the moving portion 440 is slidably coupled to the sliding guide 415. Since the moving portion 440 is coupled to a connecting protrusion 465 of the lens assembly 460 which will be explained later, vibration of the piezoelectric element 430 is transmitted to the lens assembly 460 to move the lens assembly 460.

The housing 480 supports the lens assembly 460 and the piezoelectric actuator assembly 400. The housing 480 may include an image pickup device 486 such as a charged-coupled device (CCD) sensor or a complementary metal oxide semiconductor (CMOS) sensor. Once the image pickup device 486 is mounted on the housing 480, a camera module including a lens driving module may be realized.

The housing 480 may have a substantially rectangular parallelepiped shape and may have a hollow portion 482 in which the lens assembly 460 is received. A cross-sectional shape of the housing 480 perpendicular to an optical axis, that is, a cross-sectional shape of a bottom surface of the housing 480, may have a regular square shape.

A guide unit is installed between the housing 480 and the lens assembly 460. The guide unit includes guide grooves 485, 487, and 488 formed in the housing 480, and sliders 426, 467, and 466 formed on an outer surface of the lens frame 462 to be inserted into the guide grooves 485, 487, and 488.

Positions of the guide grooves 485, 487, and 488 and the sliders 426, 467, and 466 are not limited to FIG. 16. For example, the guide grooves 485, 487, and 488 may be formed in the lens assembly 460 and the sliders 426, 467, and 466 may be formed on the housing 480.

The guide grooves 485, 487, and 488 act as rails by being coupled to the sliders 426, 467, and 466 of the lens frame 462 to guide sliding of the lens assembly 460 in the housing 480. The guide grooves 485, 487, and 488 are formed in three corners of the housing 480 in FIG. 16. However, the present embodiment is not limited thereto, and the guide grooves 485, 487, and 488 may be formed in other positions according to shapes and structures of the housing 480, the lens assembly 460, and the piezoelectric actuator assembly 400.

A first groove 484 into which a first roller assembly 468 including rollers 486a is inserted is formed in a side of the first guide groove 485 of the housing 480. A second groove 489 into which a second roller assembly 469 including rollers 469a is inserted is formed in a side of the third guide groove 487 of the housing 480. Each of the first groove 484 and the second groove 489 may have a substantially V shape.

The lens assembly 460 supports the lens unit 461 including the at least one lens and directs light indicating an image of a subject onto the image pickup device 486. The lens assembly 460 has a substantially circular cylindrical shape, and the first slider 466, the second slider 426, and the third slider 467 protrude from an outer surface of the lens frame 462 to extend in a direction in which the first through third sliders 466, 426, and 467 slide. The first slider 466 is inserted into the first guide groove 485, the second slider 426 is inserted into the second guide groove 488, and the third slider 467 is inserted into the third guide groove 487.

The sliders 426, 466, and 467 and the guide grooves 485, 487, and 488 guide a linear motion of the lens assembly 460 and help the image pickup device 486 and the lens assembly 460 to be kept parallel to each other.

When the piezoelectric actuator assembly 400 is coupled to a side opening portion 481 of the housing 480 in a state where the first slider 466 is inserted into the first guide groove 485, the coupling stage 441 is coupled to the connecting protrusion 465.

The sliders 426, 466, and 467 of the lens assembly 460 may move in a direction parallel to an optical axis of light indicating an image of a subject along the guide grooves 485, 487, and 488. That is, the lens assembly 460 can perform zooming and auto-focusing by moving along the guide grooves 485, 487, and 488.

The first slider 466 of the lens assembly 460 includes the connecting protrusion 465 formed therein. The connecting protrusion 465 is coupled to the coupling stage 441 of the piezoelectric actuator assembly 400. Accordingly, when current is applied to the piezoelectric element 430 of the piezoelectric actuator assembly 400, since vibration of the piezoelectric element 430 causes the elastic plate 420 to be deformed and the protrusion 423 repeatedly hits a bottom surface of the coupling stage 441, a driving force is applied to the connecting protrusion 465 coupled to the coupling stage 441, thereby causing the lens assembly 460 to slide in the housing 480.

Once the piezoelectric actuator assembly 400 is completely assembled, since the bottom surface of the coupling stage 441 is elastically supported by the protrusion 423 of the elastic plate 420, a pressure is exerted on the piezoelectric actuator assembly 400 in the Z-axis direction). Accordingly, although the piezoelectric actuator assembly 400 is coupled to the housing 480, the influence of an assembling tolerance can be minimized. That is, since the protrusion 423 of the elastic plate 420 is firmly attached to the bottom surface of the coupling stage 441 and provides an elastic force, the risk of displacements of elements including the coupling stage 441 while assembling is very low.

As described above, the piezoelectric actuator assembly and the optical system including the same according to the embodiments efficiently move the lens unit of the optical system since vibration of the piezoelectric element is transmitted to the moving portion through the protrusion of the elastic plate.

Furthermore, the piezoelectric actuator assembly and the optical system including the same according to the embodiments minimizes performance degradation due to a change in driving characteristics which may occur after assembling since the piezoelectric actuator assembly is manufactured as a module to maintain a state where the protrusion of the elastic plate elastically supports the moving portion. Moreover, the piezoelectric actuator assembly and the optical system including the same according to the embodiments minimize a change in driving characteristics and achieve reliable operation since the piezoelectric actuator assembly is manufactured as a module so that a state before the piezoelectric actuator assembly is assembled is not much different from a state after the piezoelectric actuator assembly is assembled and thus a change in an optical frequency is maintained within a narrow allowable range.

The device described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media such as read-only memory (ROM), random-access memory (RAM), CD-ROMs, magnetic tapes, floppy disks, and optical data storage devices. The computer readable recording media may also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. The words “mechanism” and “element” are used broadly and are not limited to mechanical or physical embodiments, but may include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention.

What is claimed is:

1. A piezoelectric actuator assembly comprising:
a base plate;
an elastic plate coupled to the base plate and including a protrusion protruding from a first surface of the elastic plate;
a piezoelectric element disposed on a second surface of the elastic plate, wherein the piezoelectric element vibrates when receiving electricity and transmits the vibration to the elastic plate; and
a moving portion having a first end supported by the protrusion of the elastic plate and a second end slidably coupled to the base plate.

2. The piezoelectric actuator assembly of claim 1, further comprising a sliding guide installed on the base plate to extend in one direction,
wherein the moving portion is coupled to the sliding guide.

3. The piezoelectric actuator assembly of claim 2, further comprising a detection sensor that detects a position of the moving portion that moves along the sliding guide.

4. The piezoelectric actuator assembly of claim 1, wherein the elastic plate further comprises mounting portions coupled to the base plate, and an elastic support portion extending from the mounting portions toward the moving portion, the elastic support portion spaced apart from the base plate, and
wherein the protrusion is formed on the elastic support portion.

5. The piezoelectric actuator assembly of claim 1, wherein the protrusion extends to have a predetermined length and is in line contact with the moving portion.

6. The piezoelectric actuator assembly of claim 1, wherein the piezoelectric element vibrates so that an end of the protrusion moves along a circular trajectory.

7. The piezoelectric actuator assembly of claim 1, wherein the piezoelectric element vibrates so that an end of the protrusion moves along an elliptical trajectory.

8. An optical system comprising:
a housing:
a lens assembly including a lens unit having at least one lens, the lens assembly also including a lens frame that supports the lens unit and moves in the housing; and
a piezoelectric actuator assembly comprising:
a base plate coupled to the housing;
an elastic plate coupled to the base plate, the elastic plate including a protrusion protruding from a first surface of the elastic plate and a piezoelectric element coupled to a second surface of the elastic plate, wherein the piezoelectric element vibrates when receiving electricity and transmits the vibration to the elastic plate; and
a moving portion that supports the lens frame, the moving portion having a first end supported by the protrusion of the elastic plate and a second end slidably coupled to the base plate.

9. The optical system of claim 8, wherein the piezoelectric actuator assembly further comprises a sliding guide installed on the base plate to extend in one direction,
wherein the moving portion is coupled to the sliding guide.

10. The optical system of claim 9, wherein the piezoelectric actuator assembly further comprises a detection sensor that detects a position of the moving portion that moves along the sliding guide.

11. The optical system of claim 8, wherein the elastic plate further includes mounting portions coupled to the base plate, and an elastic support portion extending from the mounting portions toward the moving portion, the elastic support portion spaced apart from the base plate, and
wherein the protrusion is formed on the elastic support portion.

12. The optical system of claim 8, wherein the protrusion extends to have a predetermined length and is in line contact with the moving portion.

13. The optical system of claim 8, wherein the piezoelectric element vibrates so that an end of the protrusion moves along a circular trajectory.

14. The optical system of claim 8, wherein the piezoelectric element vibrates so that an end of the protrusion moves along an elliptical trajectory.

15. The optical system of claim 8, wherein the lens assembly further includes guide shafts disposed in the housing and that support the lens frame so that the lens frame moves.

16. The optical system of claim 8, further comprising a guide unit that slidably couples the lens frame to the housing.

17. The optical system of claim 16, wherein the guide unit comprises guide grooves formed in the housing to extend in a direction in which the lens assembly slides, and sliders formed on corners of the lens frame that are inserted into the guide grooves.

18. The optical system of claim 17, wherein the guide unit further comprises rollers disposed on inner surfaces of the guide grooves that contact the sliders and slidably support the sliders.
